(19) United States
(12) Patent Application Publication
(10) Pub. No.: US 2025/0147189 A1
(43) Pub. Date: May 8, 2025

(54) METHOD FOR WIRELESS DEVICE (WD) GLOBAL NAVIGATION SATELLITE SYSTEM (GNSS) LOCAL ENVIRONMENT CHARACTERIZATION

(71) Applicant: Telefonaktiebolaget LM Ericsson (publ), Stockholm (SE)

(72) Inventors: Fredrik GUNNARSSON, Linköping (SE); Ritesh SHREEVASTAV, Upplands Väsby (SE)

(21) Appl. No.: 18/838,159

(22) PCT Filed: Feb. 13, 2023
(86) PCT No.: PCT/SE2023/050116

§ 371 Date: Aug. 13, 2024

Related U.S. Application Data
(60) Provisional application No. 63/309,961, filed on Feb. 14, 2022.

(51) Int. Cl. G01S 19/06; G01S 5/00; G01S 19/22; G01S 19/49

(52) U.S. Cl. CPC G01S 19/06; G01S 5/011; G01S 19/22; G01S 19/49

(57) ABSTRACT

A method, system and apparatus for wireless device (WD) global navigation satellite system (GNSS) local environment characterization are disclosed. According to one aspect, a method in a network node includes obtaining a capability of the WD to provide GNSS positioning metrics from the WD. The method also includes requesting the WD to provide GNSS positioning metrics with a location estimate, when a location estimate is available at the WD. The method also includes receiving from a plurality of WDs, local GNSS positioning metrics associated to the reported location estimate. The method further includes determining local GNSS positioning metrics applicable to the plurality of WDs. The method also includes transmitting a set of local GNSS positioning metrics to at least one WD.

### TECHNICAL FIELD

The present disclosure relates to wireless communications, and in particular, to wireless device (WD) global navigation satellite system (GNSS) local environment characterization.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

Positioning in 4G/LTE/evolved packet core (EPC) and 5G/NR/5G Core (5GC) is supported by the example architecture in FIG. 1, with direct interactions between a WD 22 and a location server 130 via the LTE Positioning Protocol, LPP 151. Moreover, there are also interactions between the location server 130 and the serving radio base station 110 via the LPPa protocol 152, to some extent supported by interactions between the radio base station 110 and the WD 22 via the Radio Resource Control (RRC) protocol 150. The radio base station 110 interacts with a mobility network entity 120 via a first interface protocol 153, and the mobility network entity 120 interacts with the location server 130 via a second interface protocol 154. In some applications, the location server interacts with a Global Navigation Satellite System (GNSS) correction data provider 140 via a third interface protocol 155.

In 4G/LTE/EPC and 5G/NR/5GC, the servers/nodes/functions/interfaces/protocols are named as follows:

| | Name in | Name in |
|---|---|---|
| Generic name | 4G/LTE/EPC | 5G/NR/5GC |
| Location server | Evolved Serving | Location |
| (130) | Mobile Location Center | Management Function |
| | (E-SMLC) or SLP | (LMF) or SLP |
| Radio base station | eNodeB | gNodeB |
| (110) | | |
| Mobility network | Mobility | Access and |
| entity (120) | Management Entity | Mobility Management |
| | (MME) | Function (AMF) |
| First interface | S1-MME | N2 |
| (153) | | |
| Second interface | SLs | NL1 |
| (154) | | |

In both cases, the location server may interact with the WD directly over user plane communications carrying LTE Positioning Protocol (LPP) 151 with signaling defined by Open Mobile Alliance (OMA) Secure User Plane Location (SUPL) or some other user plane signaling. In case of SUPL, the location server is denoted as a SUPL Location Platform (SLP) and the device is denoted as a SUPL Enabled Terminal (SET).

There are several options for the interface, signaling and message handling over the third interface 155 between the location server 130 and a correction data provider 140. One option is message handling defined by Radio Technical Commission for Maritime (RTCM) special committee 104 with the user plane signaling protocol Networked Transport of RTCM via Internet Protocol (NTRIP). RTCM SC 104 initially defined differential corrections to GNSS.

3GPP Technical Release 9 (3GPP Rel-9) introduced support for Global Navigation Satellite System (GNSS) assistance data, and the scope of the assistance data has been refined over the releases. In 3GPP Rel-15, support for Real Time Kinematics (RTK) GNSS was introduced. The assistance data is generated based on observations from one or more reference stations, where a reference station is a node with known position and known antenna configuration, and a GNSS receiver capable of measuring signals from one or more satellite systems, where the satellite systems comprise one or more satellites, and each satellite transmits one or more signals. Typically, the GNSS RTK assistance data is provided by a separate function, correction data provider or NRTK server 140. GNSS represents a generic system, with examples such as the Global Positioning System (GPS), GLONASS, GALILEO and BeiDou. These systems are based on a number of GNSS satellites, each transmitting GNSS signals associated to a specific GNSS signal identity. The satellites follow tailored orbits around the globe.

FIG. 2 illustrates an example of the different 4G/LTE/EPC and 5G/NR/5GC entities in the more complete and common architecture 200.

5G positioning methods based on 5G signals is realized with downlink positioning reference signals, associated to a specific radio resource, which may be transmitted using a radio beam with directivity. Each positioning reference signal is associated to an identifier. One or more such signals are transmitted from a specific transmission point associated to a radio base station 110.

Positioning methods rely on measurements, and several positioning methods rely on device measurements of GNSS signals, Wi-Fi signals, Bluetooth signals, beacon signals, radio access technology (RAT)-dependent signals, etc. Such device measurements are subject to errors or certain events, and a subset of such errors or certain events are due to the local environment of the device.

FIG. 3 illustrates one example typical of a local environment error or certain event—multipath signal propagation. In FIG. 3a, some GNSS signals are received via a line of sight path and some via a reflected non-line of sight path, FIG. 3b illustrates a similar situation for a terrestrial radio network, where some signals are received via a line of sight path and some via a reflected non-line of sight path. The time of flight of a non-line-of-sight signal does not reflect the distance between the transmitter and device, leading to a measurement error due to the local environment of the device.

Other examples of local environment measurement issues, but not limited to, are:
unintentional interference from other radio transmitters;
intentional interference from other radio transmitters, often denoted jamming; and
intentional fake radio signals to lure the device to measure radio signal time of flight not corresponding to reality, often referred to as spoofing.

### MDT

Minimization of drive test (MDT) is used as an alternative to the drive tests for obtaining certain types of WD measurement results for self-organizing network (SON) related features such as network planning, network optimization, network parameter tuning or setting (e.g., base station transmit power, number of receive and/or transmit antennas, etc.), or even for positioning (e.g., radio frequency (RF) pattern matching based positioning). The WD is configured by the network for logging the measurements. Two MDT modes exist: immediate MDT and logged MDT:
Immediate MDT comprising measurement performed by WD in the high RRC activity states (e.g., RRC CONNECTED state in LTE and NR, etc.) and the reporting of the measurements to a network node (e.g., eNodeB, gNode B, etc.) when a reporting condition is met, e.g., when an event is triggered; and
Logged MDT functionality comprising measurements performed by the WD when operating in a low RRC activity state (e.g., RRC idle, RRC inactive, etc.). The network uses Logged Measurement Configuration messaging to configure the WD to perform logging of measurement results in low RRC activity state which may be stored in the WD for up to 48 hours before reporting. The configuration comprises information such as absolute time in the cell, logging duration, logging interval or periodicity (e.g., how often the measurements are logged), information about area where logging is required, etc. The logging duration may vary from few minutes to several hours. The WD transmits the measurement results along with relative time stamp for each log, which indicates the time of logging measurement results relative to the absolute time received (received from the network), location information of the logged results (optional), etc.

A problem is that the local environment measurement issues may potentially have a degrading impact on the positioning performance. Such issues may also imply that the device estimates a position that does not correspond to the expected uncertainty, meaning that the device may errantly assume a more precise position than what is actually estimated, potentially causing serious implications if used in some automated or collaborative context.

### SUMMARY

Some embodiments advantageously provide methods, systems, and apparatuses for wireless device (WD) global navigation satellite system (GNSS) local environment characterization.

In some embodiments, methods are provided to crowd-source GNSS local environment positioning metrics and performance metrics from devices as well as to provide as assistance data local environment issues to devices to handle and prepare devices for local environment positioning metrics.

The network node is typically a location server, but may also be a radio base station or some other network node.

With local environment GNSS positioning metrics, a WD entering a region may be prepared for potential issues and may consider the potential negative impact from the local environment when assessing position estimates based on GNSS.

With crowd-sourced local environment GNSS positioning metrics, the gathering of the information may be automated, resulting in a cost-efficient introduction and operation of local environment GNSS positioning metrics.

Furthermore, the reporting of local environment GNSS positioning metrics together with GNSS-based position estimate enable a better understanding of the GNS positioning performance at the location server side—information that may be forwarded to application on the network side.

According to one aspect, a method in a network node configured to communicate with a plurality of wireless devices, WDs, is provided. The method includes obtaining a capability of the WD to provide GNSS positioning metrics. The method also includes requesting the WD to provide GNSS positioning metrics with a location estimate, when a location estimate is available at the WD. The method further includes receiving from a plurality of WDs, local GNSS positioning metrics associated to the reported location estimate. The method also includes determining local GNSS positioning metrics applicable to the plurality of WDs. The method also includes transmitting a set of local GNSS positioning metrics to be used by at least one WD.

According to this aspect, in some embodiments, the local GNSS positioning metrics include, for each of at least one WD, a number of detected satellites and a number of satellites used for positioning. In some embodiments, the set of local GNSS positioning metrics include satellite signal quality information. In some embodiments, the satellite signal quality information includes an indication whether a satellite signal is line of sight. In some embodiments, the set of local GNSS positioning metrics include an average of satellite signal measurements. In some embodiments, the set of local GNSS positioning metrics include a dilution of precision received from at least one WD of the plurality of WDs. In some embodiments, the set of local GNSS positioning metrics include a geographical reference, the geographical reference including at least one of a cell, a beam, a tracking area, a location, a line segment and a polygon. In some embodiments, the set of local GNSS positioning metrics include metrics based at least in part on position estimate classifications, the position estimate classifications including an indication of at least one of differential positioning assistance data, real time kinetic solution information and inertial measurement unit data. In some embodiments, the local GNSS positioning metrics are filtered based at least in part on a comparison of satellite signal measurements to at least one of a signal quality threshold and a signal power threshold. In some embodiments, transmitting the set of local GNSS positioning metrics to at least one WD includes one of broadcasting and unicasting the set of local GNSS positioning metrics. In some embodiments, the network node is a location server.

According to another aspect, a network node configured to communicate with a plurality of wireless devices, WDs, is provided. The network node includes processing circuitry configured to: obtain a capability of the WD to provide GNSS positioning metrics; and request the WD to provide GNSS positioning metrics with a location estimate, when a location estimate is available at the WD. The network node also includes a radio interface in communication with the processing circuitry and configured to receive from a plurality of WDs, local GNSS positioning metrics associated to a reported location estimate. The processing circuitry is further configured to determine local GNSS positioning metrics applicable to the plurality of WDs. The radio interface is further configured to transmit a set of local GNSS positioning metrics to be used by at least one WD.

According to this aspect, in some embodiments, the local GNSS positioning metrics includes, for each of at least one WD, a number of detected satellites and a number of satellites used for positioning. In some embodiments, the set of local GNSS positioning metrics include satellite signal quality information. In some embodiments, the satellite signal quality information including an indication whether a satellite signal is line of sight. In some embodiments, the set of local GNSS positioning metrics include an average of satellite signal measurements. In some embodiments, the set of local GNSS positioning metrics include a dilution of precision received from at least one WD of the plurality of WDs. In some embodiments, the set of local GNSS positioning metrics include a geographical reference, the geographical reference including at least one of a cell, a beam, a tracking area, a location, a line segment and a polygon. In some embodiments, the set of local GNSS positioning metrics include metrics based at least in part on position estimate classifications, the position estimate classifications including an indication of at least one of differential positioning assistance data, real time kinetic solution information and inertial measurement unit data. In some embodiments, the local GNSS positioning metrics are filtered based at least in part on a comparison of satellite signal measurements to at least one of a signal quality threshold and a signal power threshold. In some embodiments, transmitting the set of local GNSS positioning metrics to at least one WD includes one of broadcasting and unicasting the set of local GNSS positioning metrics. In some embodiments, the network node is a location server.

According to yet another aspect, a method in a WD configured to communicate with a network node and a plurality of satellites is provided. The method includes transmitting to the network node a capability of the WD for providing GNSS positioning metrics. The method also includes receiving a request from the network node to provide GNSS positioning metrics with a location estimate, when a location estimate is available at the WD. The method also includes
determining local GNSS positioning metrics based at least in part on satellite signal measurements by the WD. The method further includes reporting the local GNSS positioning metrics with a location estimate when a location estimate is available at the WD. The method also includes receiving regional GNSS positioning metrics from the network node, the regional GNSS positioning metrics being based at least in part on local GNSS positioning metrics received from a plurality of WDs. The method further includes determining a position of the WD based at least in part on the local and regional GNSS positioning metrics.

According to this aspect, in some embodiments, the local GNSS positioning metrics include, for each of at least one WD, a number of detected satellites and a number of satellites used for positioning. In some embodiments, the regional GNSS positioning metrics include satellite signal quality information. In some embodiments, the satellite signal quality information includes an indication whether a satellite signal is line of sight. In some embodiments, the regional GNSS positioning metrics include a dilution of precision from at least one of the plurality of WDs. In some embodiments, the local GNSS positioning metrics are based at least in part on comparisons of satellite signal measurements to at least one of a signal quality threshold and a signal power threshold. In some embodiments, the local GNSS positioning metrics include metrics based at least in part on position estimate classifications, the position estimate classifications including an indication of at least one of differential positioning assistance data, real time kinetic solution information and inertial measurement unit data.

According to another aspect, a WD configured to communicate with a network node and a plurality of satellites is provided. The WD includes a radio interface configured to: transmit to the network node a capability of the WD for providing GNSS positioning metrics; and receive a request from the network node to provide GNSS positioning metrics with a location estimate, when a location estimate is available at the WD. The WD also includes processing circuitry in communication with the radio interface and configured to determine local GNSS positioning metrics based at least in part on satellite signal measurements by the WD. The radio interface is further configured to: report the local GNSS positioning metrics with a location estimate when a location estimate is available at the WD; and receive regional GNSS positioning metrics from the network node, the regional GNSS positioning metrics being based at least in part on local GNSS positioning metrics received from a plurality of WDs. The processing circuitry is further configured to determine a position of the WD based at least in part on the local and regional GNSS positioning metrics.

According to this aspect, in some embodiments, the local GNSS positioning metrics include, for each of at least one WD, a number of detected satellites and a number of satellites used for positioning. In some embodiments, the regional GNSS positioning metrics include satellite signal quality information. In some embodiments, the satellite signal quality information includes an indication whether a satellite signal is line of sight. In some embodiments, the regional GNSS positioning metrics include a dilution of precision from at least one of the plurality of WDs. In some embodiments, the local GNSS positioning metrics are based at least in part on comparisons of satellite signal measurements to at least one of a signal quality threshold and a signal power threshold. In some embodiments, the local GNSS positioning metrics include metrics based at least in part on position estimate classifications, the position estimate classifications including an indication of at least one of differential positioning assistance data, real time kinetic solution information and inertial measurement unit data.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example network configuration;

FIG. 2 is a more detailed example of a network configuration;

FIG. 3 is an example of a terrestrial network in communication with a satellite network;

FIG. 4 is a schematic diagram of an example network architecture illustrating a communication system according to principles disclosed herein;

FIG. 5 is a block diagram of a network node in communication with a wireless device over a wireless connection according to some embodiments of the present disclosure;

FIG. 6 is a flowchart of an example process in a network node for wireless device (WD) global navigation satellite system (GNSS) local environment characterization;

FIG. 7 is a flowchart of an example process in a wireless device for wireless device (WD) global navigation satellite system (GNSS) local environment characterization;

FIG. 8 is a flowchart of another example process in a network node for wireless device (WD) global navigation satellite system (GNSS) local environment characterization;

FIG. 9 is a flowchart of another example process in a wireless device for wireless device (WD) global navigation satellite system (GNSS) local environment characterization;

FIG. 10 is a flowchart of an example process in a WD according to principles disclosed herein;

FIG. 11 is a flowchart of another example process in a WD according to principles disclosed herein;

FIG. 12 is flowchart of an example process in a network node according to principles disclosed herein;

FIG. 13 is a signaling chart for some embodiments according to principles set forth herein;

FIG. 14 is a flowchart of an example process in a WD for obtaining regional GNSS position assistance datal according to principles disclosed herein;

FIG. 15 is a flowchart of a virtual apparatus such as WD;

FIG. 16 is flowchart of an example process in a network node for determining regional GNSS position assistance data according to principles disclosed herein;

FIG. 17 is a block diagram of a virtual apparatus such as a network node constructed according to principles disclosed herein; and

FIG. 18 is a flowchart of an example process in a network node according to principles disclosed herein; and

FIG. 19 is a flowchart of an example process in a wireless device according to principles disclosed herein.

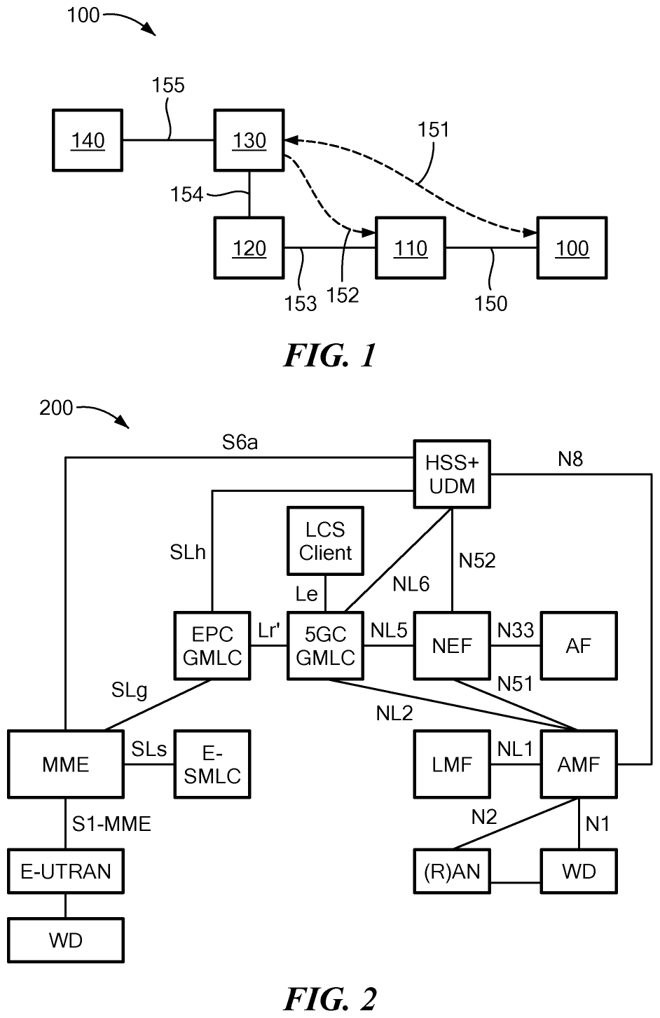

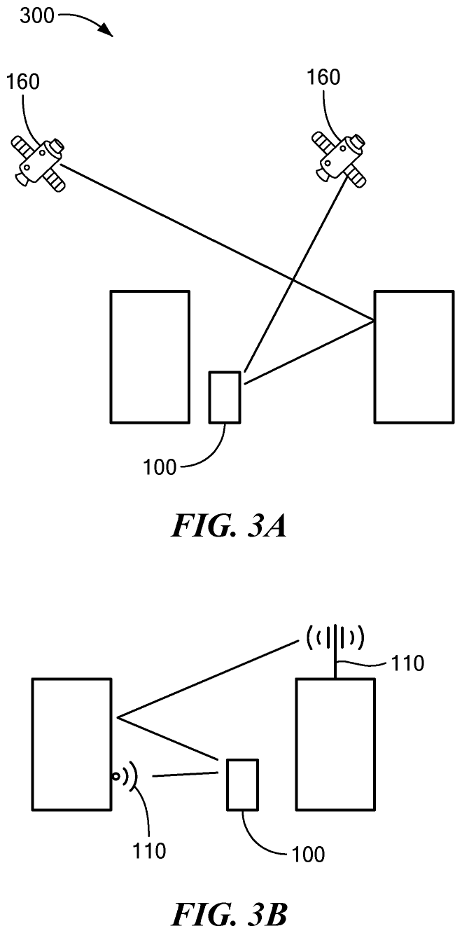

### DETAILED DESCRIPTION

Before describing in detail example embodiments, it is noted that the embodiments reside primarily in combinations of apparatus components and processing steps related to wireless device (WD) global navigation satellite system (GNSS) local environment characterization. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a” “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3^{rd} party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

As used herein, the term device includes a wireless device (WD). Local environment GNSS positioning data refers to data acquired by one or more WD whose positions are being determined. The local environment GNSS positioning data may be based at least in part on signals received from GNSS satellites and/or GNSS ground stations and signal conditions experienced by the WDs. Regional GNSS positioning data refers to data acquired by the network node, such as a radio base station or a location server. Regional GNSS positioning data may be based at least in part on signals and data received by the network node from the WDs as well as from GNSS satellites and/or GNSS ground stations. A GNSS ground station may include a GPS ground segment (CS) station, for example, and may include any ground station that provides signals containing information to assist in a position determination.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to wireless device (WD) global navigation satellite system (GNSS) local environment characterization.

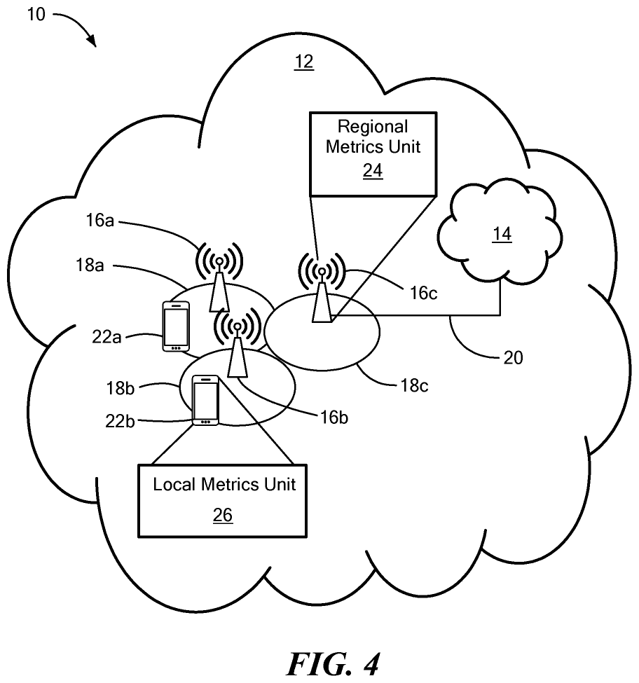

Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

A network node 16 (eNB or gNB) is configured to include a regional metrics unit 24 which is configured to determine local environment global navigation satellite system, GNSS, positioning metrics. The regional metrics unit 24 may also be configured to determine local GNSS positioning metrics applicable to the plurality of WDs. A wireless device 22 is configured to include a local metrics unit 26 which is configured to determine the requested local environment GNSS positioning metrics and positioning information. The local metrics unit 26 may also be configured to determine a position of the WD 22 based at least in part on the local and regional GNSS positioning metrics.

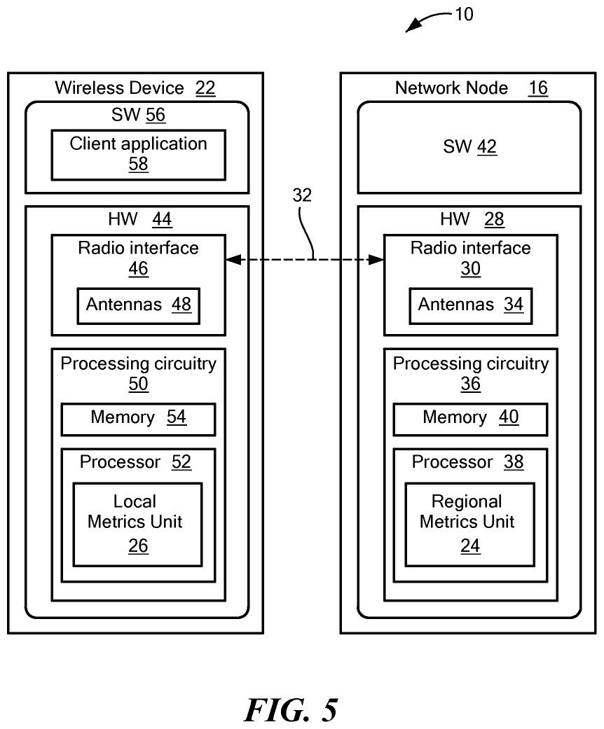

Example implementations, in accordance with an embodiment, of the WD 22 and network node 16 discussed in the preceding paragraphs will now be described with reference to FIG. 5.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include regional metrics unit 24 which is configured to determine local environment global navigation satellite system, GNSS, positioning metrics. The regional metrics unit 24 may also be configured to determine local GNSS positioning metrics applicable to the plurality of WDs.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include a local metrics unit 26 which is configured to determine the requested local environment GNSS positioning metrics and positioning information. The local metrics unit 26 may also be configured to determine a position of the WD 22 based at least in part on the local and regional GNSS positioning metrics.

In some embodiments, the inner workings of the network node 16 and WD 22 may be as shown in FIG. 5 and independently, the surrounding network topology may be that of FIG. 4.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 4 and 5 show various “units” such as regional metrics unit 24 and local metrics unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

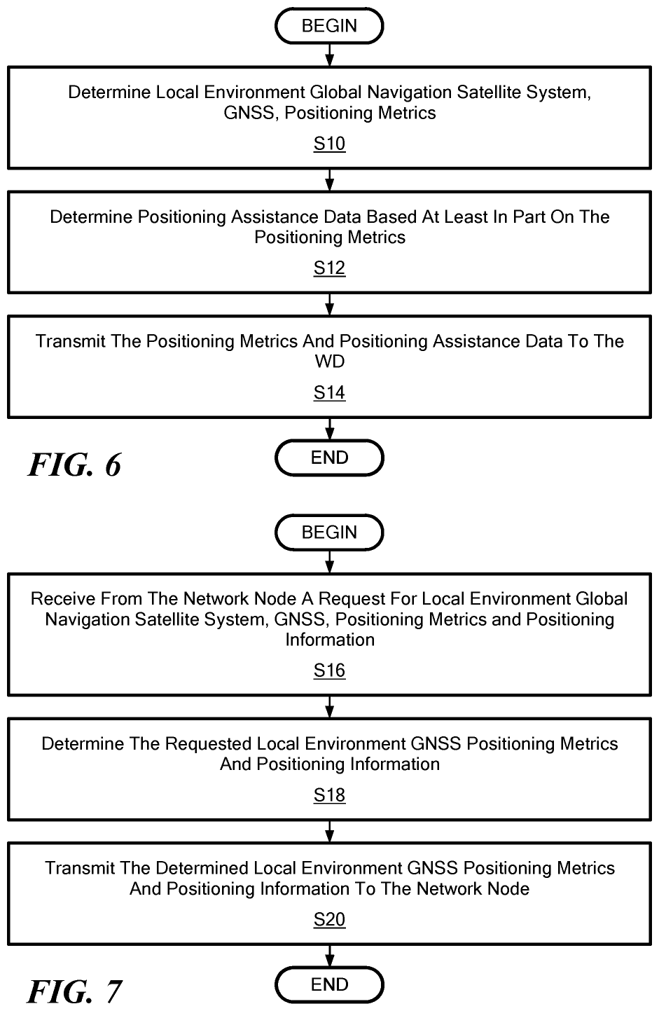

FIG. 6 is a flowchart of an example process in a network node 16 for wireless device (WD) global navigation satellite system (GNSS) local environment characterization. One or more blocks described herein may be performed by one or more elements of network node 16 such as by one or more of processing circuitry 36 (including the regional metrics unit 24), processor 38, and/or radio interface 30. Network node 16 such as via processing circuitry 36 and/or processor 38 and/or radio interface 30 is configured to determine local environment global navigation satellite system, GNSS, positioning metrics (Block S10). The process also includes determining positioning assistance data based at least in part on the positioning metrics (Block S12). The process also includes transmitting the positioning metrics and positioning assistance data to the WD (Block S14).

In some embodiments, the process also includes pre-determining whether the WD is capable of supporting local environment GNSS positioning metrics. In some embodiments, the positioning metrics are determined based at least in part on stored assistance data. In some embodiments, the positioning metrics are based at least in part on at least one of a geographical reference, satellite signal measurements and satellite positions.

FIG. 7 is a flowchart of an example process in a wireless device 22 according to some embodiments of the present disclosure. One or more blocks described herein may be performed by one or more elements of wireless device 22 such as by one or more of processing circuitry 50 (including the local metrics unit 26), processor 52, and/or radio interface 46. Wireless device 22 such as via processing circuitry 50 and/or processor 52 and/or radio interface 46 is configured to receive from the network node a request for local environment global navigation satellite system, GNSS, positioning metrics and positioning information (Block S16). The process also includes determining the requested local environment GNSS positioning metrics and positioning information (Block S18). The process further includes transmitting the determined local environment GNSS positioning metrics and positioning information to the network node (Block S20).

In some embodiments, the process further includes receiving local environment GNSS positioning metrics from the network node and determine the positioning information based at least in part on the local environment GNSS positioning metrics. In some embodiments, the local environment GNSS positioning metrics are based at least in part on at least one of satellite signal measurements, satellite positions and differential positioning assistance information. In some embodiments, the process also includes transmitting to the network node a capability to use local environment GNSS positioning metrics.

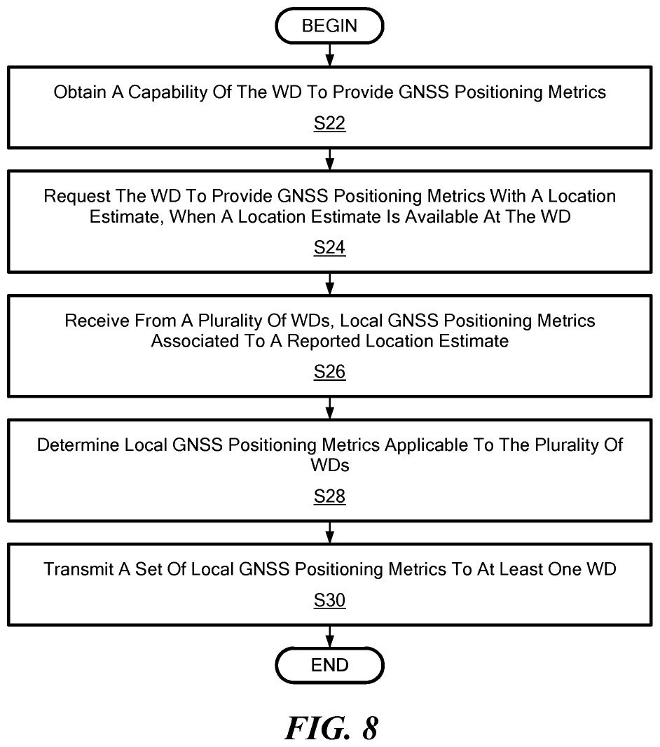

FIG. 8 is a flowchart of an example process in a network node 16 for wireless device (WD) global navigation satellite system (GNSS) local environment characterization. One or more blocks described herein may be performed by one or more elements of network node 16 such as by one or more of processing circuitry 36 (including the regional metrics unit 24), processor 38, and/or radio interface 30. Network node 16 such as via processing circuitry 36 and/or processor 38 and/or radio interface 30 is configured to obtain a capability of the WD to provide GNSS positioning metrics (Block S22). The process also includes requesting the WD to provide GNSS positioning metrics with a location estimate, when a location estimate is available at the WD (Block S24). The process further includes receiving from a plurality of WDs, local GNSS positioning metrics associated to the reported location estimate (Block S26). The process also includes determining local GNSS positioning metrics applicable to the plurality of WDs (Block S28). The process also includes transmitting a set of local GNSS positioning metrics to be used by at least one WD (Block S30).

In some embodiments, the local GNSS positioning metrics include, for each of at least one WD, a number of detected satellites and a number of satellites used for positioning. In some embodiments, the set of local GNSS positioning metrics include satellite signal quality information. In some embodiments, the satellite signal quality information includes an indication whether a satellite signal is line of sight. In some embodiments, the set of local GNSS positioning metrics include an average of satellite signal measurements. In some embodiments, the set of local GNSS positioning metrics include a dilution of precision received from at least one WD of the plurality of WDs. In some embodiments, the set of local GNSS positioning metrics include a geographical reference, the geographical reference including at least one of a cell, a beam, a tracking area, a location, a line segment and a polygon. In some embodiments, the set of local GNSS positioning metrics include metrics based at least in part on position estimate classifications, the position estimate classifications including an indication of at least one of differential positioning assistance data, real time kinetic solution information and inertial measurement unit data. In some embodiments, the local GNSS positioning metrics are filtered based at least in part on a comparison of satellite signal measurements to at least one of a signal quality threshold and a signal power threshold. In some embodiments, transmitting the set of local GNSS positioning metrics to at least one WD includes one of broadcasting and unicasting the set of local GNSS positioning metrics. In some embodiments, the network node is a location server.

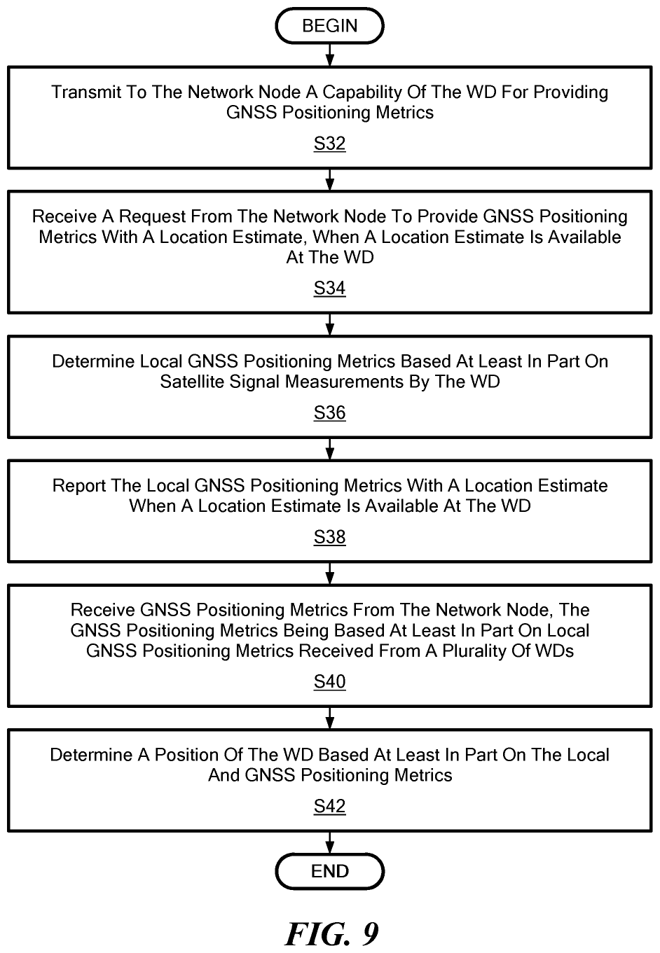

FIG. 9 is a flowchart of an example process in a wireless device 22 according to some embodiments of the present disclosure. One or more blocks described herein may be performed by one or more elements of wireless device 22 such as by one or more of processing circuitry 50 (including the local metrics unit 26), processor 52, and/or radio interface 46. Wireless device 22 such as via processing circuitry 50 and/or processor 52 and/or radio interface 46 is configured to transmit to the network node a capability of the WD for providing GNSS positioning metrics (Block S32). The process also includes receiving a request from the network node to provide GNSS positioning metrics with a location estimate, when a location estimate is available at the WD (Block S34). The process further includes determining local GNSS positioning metrics based at least in part on satellite signal measurements by the WD (Block S36). The process also includes reporting the local GNSS positioning metrics with a location estimate when a location estimate is available at the WD (Block S38). The process also includes receiving regional GNSS positioning metrics from the network node, the regional GNSS positioning metrics being based at least in part on local GNSS positioning metrics received from a plurality of WDs (Block S40). The process also includes determining a position of the WD based at least in part on the local and regional GNSS positioning metrics (Block S42).

In some embodiments, the local GNSS positioning metrics include, for each of at least one WD, a number of detected satellites and a number of satellites used for positioning. In some embodiments, the regional GNSS positioning metrics include satellite signal quality information. In some embodiments, the satellite signal quality information includes an indication whether a satellite signal is line of sight. In some embodiments, the regional GNSS positioning metrics include a dilution of precision from at least one of the plurality of WDs. In some embodiments, the local GNSS positioning metrics are based at least in part on comparisons of satellite signal measurements to at least one of a signal quality threshold and a signal power threshold. In some embodiments, the local GNSS positioning metrics include metrics based at least in part on position estimate classifications, the position estimate classifications including an indication of at least one of differential positioning assistance data, real time kinetic solution information and inertial measurement unit data.

Having described the general process flow of arrangements of the disclosure and having provided examples of hardware and software arrangements for implementing the processes and functions of the disclosure, the sections below provide details and examples of arrangements for wireless device (WD) global navigation satellite system (GNSS) local environment characterization.

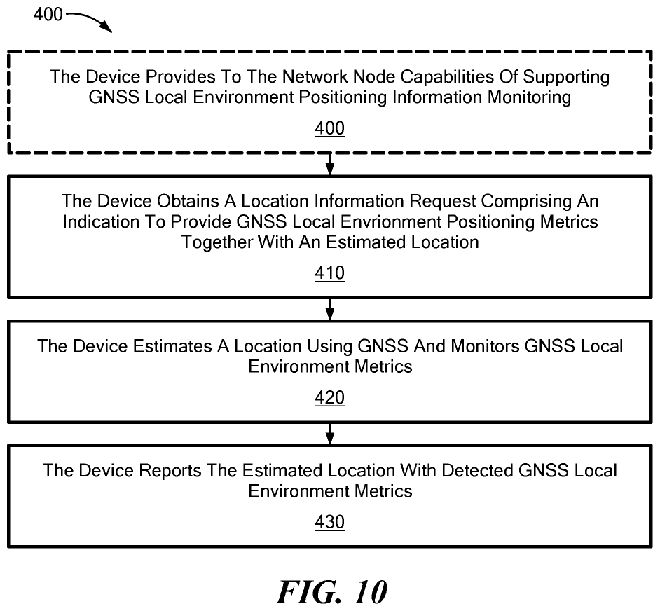

From the perspective of the WD 22, for GNSS local environment GNSS positioning, FIG. 10 illustrates some steps performed in some embodiments. The WD provides additional information about the GNSS positioning to the network. Optionally (step 400), the WD 22 provides to the network node (optionally upon request from the network node) capabilities for supporting the reporting of local environment GNSS positioning metrics. As a capable WD 22, the WD 22 obtains (step 410) a location information request, from a network node, further including a request for GNSS local environment positioning metrics. The WD 22 performs GNSS positioning and monitors local environment positioning metrics (step 420) such as, but not limited to, satellite signal multipath, number of detected satellites, number of used satellites for positioning, satellite signal quality, positioning engine metrics, etc. In step 430, the WD 22 reports, to a network node, local environment GNSS positioning metrics.

The network node 16 may be a radio base station (110), a location server (130) or some other network node.

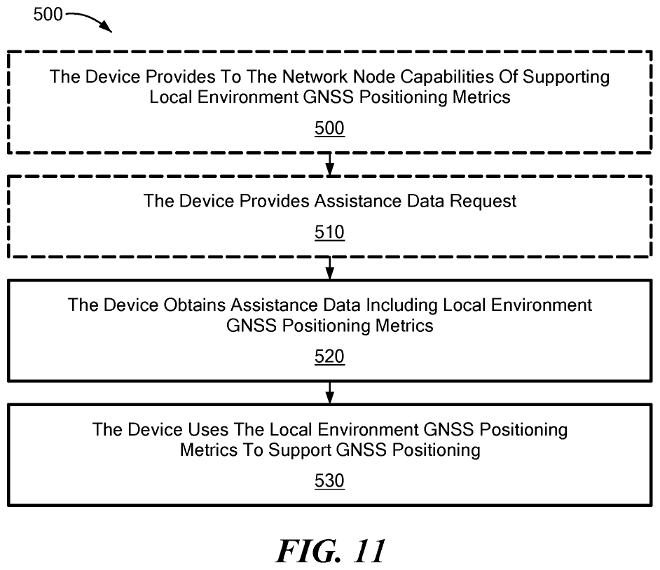

From the perspective of the WD 22 for supporting positioning based on assistance data with local environment GNSS positioning metrics, FIG. 11 illustrates steps performed by some embodiments. Optionally (step 500), the WD 22 provides to the network node (optionally upon request from the network node) capabilities for supporting local environment GNSS positioning metrics. Furthermore, optionally (step 510), the target WD 22 provides an assistance data request to the network node for positioning assistance data. In step 520, the WD 22 obtains, from the network node, assistance data together with local environment GNSS positioning metrics. In step 530, the WD 22 uses the local environment GNSS positioning metrics to support positioning.

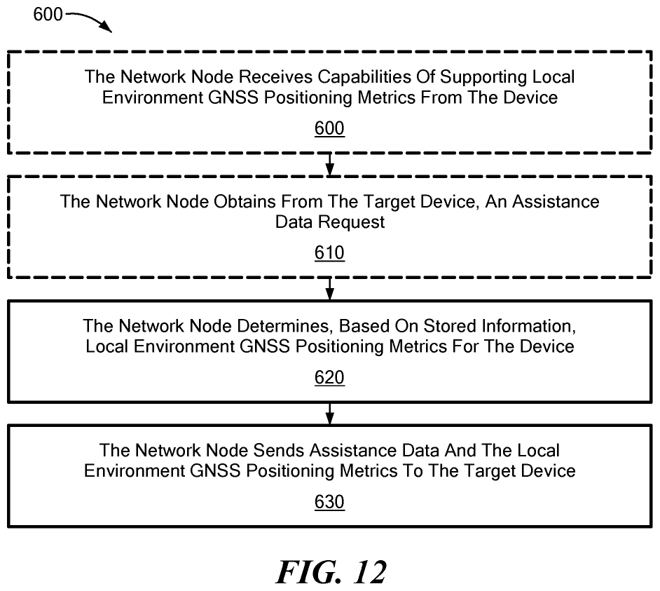

From the perspective of the network node for positioning support based on assistance data with local environment GNSS positioning metrics, FIG. 12 illustrates steps performed by some embodiments. Optionally (step 600), the network node receives from the WD 22, (optionally upon request from the network node) capabilities for supporting local environment GNSS positioning metrics. Furthermore, optionally (step 610), the network node obtains, from the target WD 22, an assistance data request for assistance data. In step 620, the network node determines, based on stored assistance data configuration, local environment GNSS positioning metrics. In step 630, the network node provides, to the WD 22, positioning assistance data together with local environment GNSS positioning metrics.

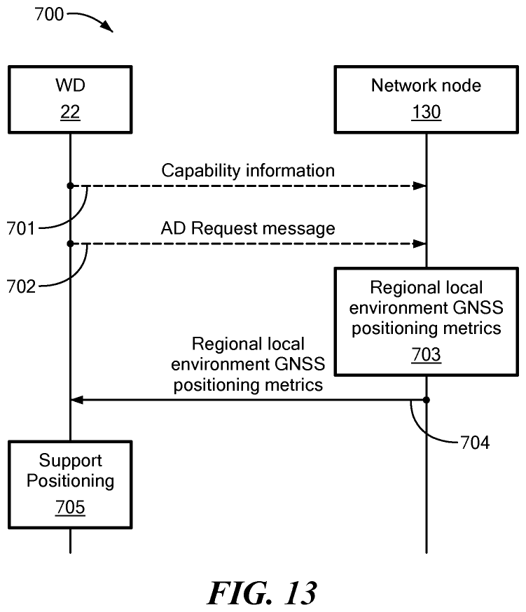

FIG. 13 provides an example signaling chart in accordance with an embodiment. Optionally (step 701), the WD 22 provides to the network node (optionally upon request from the network node) capabilities for supporting local environment GNSS positioning metrics. Furthermore, optionally (step 702), the target device (WD 22) provides an assistance data request to the network node for positioning assistance data. In step 703, the network node determines, based on stored assistance data configuration, local environment GNSS positioning metrics. In step 704, the network node provides, to the WD 22, positioning assistance data together with a local environment GNSS positioning metrics. In step 705, the WD 22 uses the local environment GNSS positioning metrics to support positioning.

### Device Reporting of Local Environment Measurement Metrics

The reporting of local environment GNSS positioning metrics is illustrated by FIG. 10, and the following configuration (step 410) and reporting (step 430) options are described here in more detail.

Optionally, there is a step 400 where the WD 22 provides capabilities to the network node associated to its ability to support information about local environment GNSS positioning metrics.

### Detecting Local Environment GNSS Positioning Metrics

The WD 22 may be capable of detecting local environment GNSS positioning metrics. In some embodiments, step 420 includes one or more of the following:
The WD 22 notes the number of detected satellites and the number of satellites used for positioning. These numbers may be different since the WD 22 may discard some satellites due to one or more of the following:
   different filters (such as an elevation mask, where satellites close to the horizon are discarded);
   different outlier detectors, which identifies satellite signal measurements that are not consistent with the rest of the satellite signal measurements and therefore removed from the positioning, where examples may include:
      Receiver Autonomous Integrity Monitoring (RAIM) algorithms, which make use of measurement redundancy to check the relative consistency among them (by means of the residuals) and in case of detection, the most likely “failed” satellite is determined. An assumption usually made in RAIM algorithms for civil aviation is that only one satellite may be faulty, i.e., the probability of multiple satellite failures is negligible; and/or
      Random sample consensus (RANSAC)—an iterative method to estimate parameters of a mathematical model from a set of observed data that contains outliers, when outliers are to be accorded no influence on the values of the estimates; and/or
   different signal quality thresholds (discarding low signal quality satellites, satellites where the first signal path is not the strongest path, indicating that it may be a non-line of sight path, etc.);
The WD 22 records satellite quality information in terms of signal to noise ratio or carrier to noise ratio. These values for the set of all satellite signal measurements may be reduced to a value representing them. The representative value may be, for example:
   The average value for the set of satellite signal measurements used for estimating the position;
   The strongest value over the set of satellite signal measurements; and/or
   The Nth strongest value of the set of satellite signal measurements;
The geometry of the set of satellites used for positioning, for example in terms of geometric dilution of precision (GDOP) or Horizontal Dilution of Precision (HDOP). These are metrics of how errors in the measurements relate to the position error. Therefore, the relative satellite-receiver geometry plays a role in determining the precision of estimated positions and times. Due to the relative geometry of any given satellite to a receiver, the precision in the pseudo range of the satellite translates to a corresponding component in each of the four dimensions of position measured by the receiver, x, y, z and time. The precision of multiple satellites in view of a receiver, are combined according to the relative position of the satellites to determine the level of precision in each dimension of the receiver measurement. When visible navigation satellites are close together in the sky, the geometry is said to be weak and the dilution of precision (DOP) value is high; when far apart, the geometry is strong and the DOP value is low:
   Geometric dilution of precision (GDOP)—the combined 3D position and time error divided by the error in the measurement;
   Horizontal dilution of precision (HDOP)—the 2D position error divided by the error in the measurement;
The positioning engine position estimate classification, such as standalone (no assistance data used), differential GPS assistance data used, GNSS RTK float solution (number of signal wavelengths to the satellites represented by a non-integer), GNSS RTK fix solution (number of signal wavelengths to the satellites represented by a integer), estimated fix such as using an inertial measurement unit (IMU). The representation may be based on the categories defined in National Marine Electronics Association (NMEA) GPS fix data (GGA) sentences for position estimate information:
   0=Invalid, no position available;
   1=Autonomous GPS fix, no correction data used;
   2=DGPS fix, using a local DGPS base station or correction service such as WAAS or EGNOS;
   3=PPS fix;
   4=RTK fix;
   5=RTK Float;
   6=Estimated fix (dead reckoning);
   7=Manual input mode;
   8=Simulation mode;
The age of the considered assistance data for the position estimate. In case different data has different ages, then a representative value is used, such as the age of the most recent data.

### Device Configuration and Reporting Via LPP

In case of LTE positioning protocol (LPP), some embodiments may include

### Step 400: Request/Provide WD 22 Capabilities:

which may be implemented as a new capability for GNSS positioning metrics in the A-GNSS-ProvideCapabilities information element.

### A-GNSS-ProvideCapabilities

The information element (IE) A-GNSS-Provide-Capabilities may be used by the target WD 22 to indicate its capability to support A-GNSS and to provide its A-GNSS location capabilities (e.g., GNSSs and assistance data supported) to the location server. For example:

```
    -- ASN1START
    A-GNSS-ProvideCapabilities ::= SEQUENCE {
```

| | | |
|---|---|---|
| gnss-SupportList | GNSS-SupportList | OPTIONAL, |
| assistanceDataSupportList | AssistanceDataSupportList | OPTIONAL, |

| | |
|---|---|
| locationCoordinateTypes | LocationCoordinateTypes |

OPTIONAL,

| | | |
|---|---|---|
| velocityTypes | VelocityTypes | OPTIONAL, |

```
      ...,
      [[ periodicalReportingNotSupported-r14
```

| | |
|---|---|
| PositioningModes | OPTIONAL, |

idleStateForMeasurements-r14

ENUMERATED { required }

```
  OPTIONAL
      ]],
      [[ periodicAssistanceData-r15
```

BIT STRING { solicited (0),
unsolicited (1) } (SIZE (1..8))

```
  OPTIONAL
      ]]
    }
    GNSS-SupportList ::= SEQUENCE (SIZE(1..16)) OF GNSS-SupportElement
    GNSS-SupportElement ::= SEQUENCE {
```

| gnss-ID | GNSS-ID, | |
|---|---|---|
| sbas-IDs | SBAS-IDs | OPTIONAL, -- |

Cond GNSS-ID-SBAS

| agnss-Modes | PositioningModes, | |
|---|---|---|
| gnss-Signals | GNSS-SignalIDs, | |
| fta-MeasSupport | SEQUENCE { | |
| | cellTime | AccessTypes, |
| | mode | PositioningModes, |
| | ... | |
| | } | OPTIONAL, -- |

Cond fta

| | |
|---|---|
| adr-Support | BOOLEAN, |
| velocityMeasurementSupport | BOOLEAN, |

```
      ...,
      [[
```

| | |
|---|---|
| adrEnhancementsSupport-r15 | ENUMERATED { true } |

OPTIONAL,

| | | |
|---|---|---|
| ha-gnss-Modes-r15 | PositioningModes | OPTIONAL |

```
      ]],
      [[
```

| | |
|---|---|
| ha-gnss-metrics-Support-r17 | ENUMERATED { true } |

```
  OPTIONAL,
      ]]
      }
    AssistanceDataSupportList ::= SEQUENCE {
```

| | |
|---|---|
| gnss-CommonAssistanceDataSupport | GNSS- |

CommonAssistanceDataSupport,

| | |
|---|---|
| gnss-GenericAssistanceDataSupport | GNSS- |

```
GenericAssistanceDataSupport,
      ...
    }
    -- ASN1STOP
```

| Conditional | |
|---|---|
| presence | Explanation |
| GNSS-ID-SBAS | The field is mandatory present if the |
| | GNSS-ID = sbas; otherwise it is not present. |
| fta | The field is mandatory present if the target |
| | device supports the reporting of fine time |
| | assistance measurements; otherwise it is not |
| | present. |

```
A-GNSS-ProvideCapabilities field descriptions
gnss-SupportList
  This field specifies the list of GNSS supported by the target device
and the target device capabilities associated with each of the supported
GNSS. This field is present if the gnss-SupportListReq in the
A-GNSS—RequestCapabilities IE is set to TRUE and if the target device
supports the A-GNSS positioning method. If the IE A-GNSS-Provide-
Capabilities is provided unsolicited, this field is included if the target
device supports the assisted GNSS positioning method.
gnss-ID
  This field specifies the GNSS supported by the target device for
which the capabilities in GNSS-SupportElement are provided.
sbas-IDs
  This field specifies the SBAS(s) supported by the target device. This
is represented by a bit string, with a one-value at the bit position means
the particular SBAS is supported; a zero-value means not supported.
agnss-Modes
  This field specifies the GNSS mode(s) supported by the target
device for the GNSS indicated by gnss-ID. This is represented by a bit
string, with a one-value at the bit position means the particular GNSS
mode is supported; a zero-value means not supported.
gnss-Signals
  This field specifies the GNSS signal(s) supported by the target
device for the GNSS indicated by gnss-ID. This is represented by a bit
string, with a one-value at the bit position means the particular GNSS
signal type is supported; a zero-value means not supported.
fta-MeasSupport
  This field specifies that the target device is capable of performing
fine time assistance measurements (i.e., GNSS-cellular time
association reporting). The cellTime field specifies for which
cellular network(s) this capability is supported. This is
represented by a bit string, with a one-value at the bit position
means FTA measurements for the specific cellular network
time is supported; a zero-value means not supported. The mode
field specifies for which GNSS mode(s) FTA measurements
are supported by the target device. This is represented by a bit
string, with a one-value at the bit position means FTA measurements
for the GNSS mode is supported; a zero-value means not supported.
adr-Support
  This field specifies whether the target device supports ADR
measurement reporting. TRUE means supported.
velocityMeasurementSupport
  This field specifies whether the target device supports measurement
reporting related to velocity. TRUE means supported.
assistanceDataSupportList
  This list defines the assistance data and assistance data choices
supported by the target device. This field is present if the assistance
DataSupportListReq in the A-GNSS-RequestCapabilities IE is set to
TRUE and if the target device supports GNSS assistance data. If the
IE A-GNSS-Provide-Capabilities is provided unsolicited, this field is
included if the target device supports any GNSS assistance data.
locationCoordinateTypes
  This parameter identifies the geographical location coordinate types
that a target device supports for GNSS. TRUE indicates that a
location coordinate type is supported and FALSE that it is not.
This field is present if the locationVelocityTypesReq in the
A-GNSS-RequestCapabilities IE is set to TRUE and if the
target device supports WD-based or standalone GNSS positioning
method. If the IE A-GNSS-Provide-Capabilities is provided
unsolicited, this field is included if the target device supports
WD-based or standalone GNSS positioning method.
velocityTypes
  This parameter identifies the velocity types that a target device
supports for GNSS. TRUE indicates that a velocity type is supported
and FALSE that it is not. FALSE for all velocity types indicates
that velocity reporting is not supported. This field is present if the
locationVelocityTypesReq in the A-GNSS-RequestCapabilities
IE is set to TRUE and if the target device supports WD-based or
standalone GNSS positioning method. If the IE A-GNSS-Provide-
Capabilities is provided unsolicited, this field is included if the target
device supports WD-based or standalone GNSS positioning method.
periodicalReportingNotSupported
  This field, if present, specifies the positioning modes for which the
target device does not support periodicalReporting. This is represented
by a bit string, with a one-value at the bit position means
periodicalReporting for the positioning mode is not supported;
a zero-value means supported. If this field is absent, the location
server may assume that the target device supports periodicalReporting
in CommonIEsRequestLocationInformation for each supported
positioning mode.
idleStateForMeasurements
  This field, if present, indicates that the target device requires idle
state to perform GNSS measurements.
periodicAssistanceData
  This field identifies the periodic assistance data delivery procedures
supported by the target device. This is represented by a bit string,
with a one value at the bit position means the periodic
assistance data delivery procedure is supported; a zero
value means not supported. Bit 0 (solicited) represents the
procedure according to clause 5.2.1a; bit (1) (unsolicited)
represents the procedure according to clause 5.2.2a.
adrEnhancementsSupport
  This field, if present, indicates that the target device supports the
fields adrMSB, adrSign, adrRMSerror, and delta-codePhase in IE-
GNSSMeasurementList.
  This field may only be present if adr-Support is set to TRUE, and is
absent if adr-Support is set to FALSE.
ha-gnss-Modes
  This field specifies the High-Accuracy GNSS mode(s) supported by
the target device for the GNSS indicated by gnss-ID. This is represented
by a bit string, with a one-value at the bit position means the
particular GNSS mode is supported; a zero-value means not supported.
ha-gnss-metrics-Support
  This field specifies that high accuracy GNSS positioning metrics are
supported by the target device
```

### Step 410: Request Location Information:

Addition of a new request for GNSS positioning metrics in the A-GNSS-RequestLocationInformation information element.

### A-GNSS-RequestLocationInformation

The IE A-GNSS-RequestLocationInformation may be used by the location server to request location information from the target WD 22 using GNSS:

| -- ASN1START | |
|---|---|
| A-GNSS-RequestLocationInformation ::= SEQUENCE { | |
| gnss-PositioningInstructions | GNSS-PositioningInstructions, |

...
}
-- ASN1STOP

### —GNSS-PositioningInstructions

The IE GNSS-PositioningInstructions is used to provide GNSS measurement instructions.

```
  -- ASN1START
  GNSS-PositioningInstructions ::= SEQUENCE {
```

| | |
|---|---|
| gnss-Methods | GNSS-ID-Bitmap, |
| fineTimeAssistanceMeasReq | BOOLEAN, |
| adrMeasReq | BOOLEAN, |
| multiFreqMeasReq | BOOLEAN, |
| assistanceAvailability | BOOLEAN, |

```
    ...,
    [[
```

| | |
|---|---|
| ha-GNSS-Req-r15 | ENUMERATED { true } |
| | OPTIONAL |

```
-- Cond WDB
    ]],
    [[
      ha-GNSS-metrics-Req-r17 ENUMERATED { basic, detailed }
OPTIONAL -- Cond WDB
    ]]
  }
  -- ASN1STOP
```

| Conditional | |
|---|---|
| presence | Explanation |
| UEB | The field is optionally present, need OP, if the |
| | locationInformationType is set to |
| | locationEstimateRequired, locationEstimatePreferred, |
| | or locationMeasurementsPreferred; oltherwise it is not |
| | present. |

```
GNSS-PositioningInstructions field descriptions
gnssMethods
  This field indicates the satellite systems allowed by the location
server. This is represented by a bit string in GNSS-ID-Bitmap, with a
one-value at the bit position means the particular GNSS is allowed;
a zero-value means not allowed. The target device does not request
assistance data or report or obtain measurements for systems
that are not indicated in this bit map. At least one of the bits in
this bit map is set to value one.
fineTimeAssistanceMeasReq
  This field indicates whether the target device is requested to report
GNSS-network time association. TRUE means requested.
adrMeasReq
  This field indicates whether the target device is requested to include
ADR measurements in GNSS-MeasurementList IE or not. TRUE
means requested.
multiFreqMeasReq
  This field indicates whether the target device is requested to report
measurements on multiple supported GNSS signal types in GNSS-
MeasurementList IE or not. TRUE means requested.
assistanceAvailability
  This field indicates whether the target device may request additional
GNSS assistance data from the server. TRUE means allowed and
FALSE means not allowed.
ha-GNSS-Req
  This field, if present, indicates that any location estimate provided by
the target device should be obtained using high accuracy RTK/PPP
methods.
ha-GNSS-metrics-Req
  This field, if present, indicates that any location estimate provided by
the target device should be reported with GNSS positioning metrics,
  either as a basic or detailed scope.
```

### Step 430: Provide Location Information:

Addition of a new request for GNSS positioning metrics in the A-GNSS-ProvideLocationInformation information element.

### A-GNSS-ProvideLocationInformation

The IE A-GNSS-ProvideLocationInformation is used by the target WD 22 to provide location measurements (e.g., pseudo-ranges, location estimate, velocity) to the location server, together with time information. It may also be used to provide a GNSS positioning specific error reason:

```
    -- ASN1START
    A-GNSS-ProvideLocationInformation ::= SEQUENCE
```

| | |
|---|---|
| gnss-SignalMeasurementInformation | GNSS- |
| SignalMeasurementInformation | OPTIONAL, |
| gnss-LocationInformation | GNSS- |
| | LocationInformation |

OPTIONAL,

| | |
|---|---|
| gnss-Error | A-GNSS-Error |

```
  OPTIONAL,
      ...
    }
    -- ASN1STOP
```

### —GNSS-LocationInformation

The IE GNSS-LocationInformation is included by the target WD 22 when location and optionally velocity information derived using GNSS or hybrid GNSS and other measurements is provided to the location server:

-- ASN1START
GNSS-LocationInformation ::= SEQUENCE

| | |
|---|---|
| measurementReferenceTime | MeasurementReferenceTime, |
| agnss-List | GNSS-ID-Bitmap, |

```
  ... ,
  [[
```

| | |
|---|---|
| ha-GNSS-metrics-r17 | HA-GNSS-Metrics-r17 OPTIONAL |

]]
}
-- ASN1STOP

```
GNSS-LocationInformation field descriptions
measurementReferenceTime
  This field specifies the GNSS system time for which the location
estimate and optionally velocity are valid. It may also include
GNSS-network time relationship, if requested by the location
server and supported by the target device.
agnss-List
  This field provides a list of satellite systems used by the target
device to calculate the location estimate and velocity estimate,
if included. This is represented by a bit string in GNSS-ID-
Bitmap, with a one-value at the bit position means the particular
method has been used; a zero-value means not used.
ha-GNSS-metrics
  This field provides GNSS positioning metrics associated
to the reported location estimate.
```

### HA-GNSS-Metrics

The IE HA-GNSS-Metrics is included by the target WD 22 when GNSS positioning metrics associated to a location estimate is provided to the location server:

```
  -- ASN1START
  HA-GNSS-Metrics-r17 ::= CHOICE
```

| | |
|---|---|
| basic-ha-GNSS-metrics-r17 | Basic-HA-GNSS-Metrics-r17, |
| detailed-ha-GNSS-metrics-r17 | Detailed-HA-GNSS-Metrics-r17, |

```
  }
  Basic-HA-GNSS-Metrics-r17 ::= SEQUENCE
```

| | |
|---|---|
| nrofDetectedSatellites-r17 | INTEGER (0..128), |
| nrofUsedSatellites-r17 | INTEGER (0..64), |
| hdopi-r17 | ENUMERATED (f10, f11, f12, f13, f14, f15, f16, |

f17, f18, f19, f20, f21, f22, f23, f24, f25, f26, f27, f28, f29, i3, i4, i5, i6, i8, i10, i15,
i20, gt20},

| | |
|---|---|
| pdopi-r17 | ENUMERATED (f10, f11, f12, f13, f14, f15, f16, |

f17, f18, f19, f20, f21, f22, f23, f24, f25, f26, f27, f28, f29, i3, i4, i5, i6, i8, i10, i15,
i20, gt20}
OPTIONAL,

| | |
|---|---|
| fixq-r17 | INTEGER (0..8), |

```
  }
  Detailed-HA-GNSS-Metrics-r17 ::= SEQUENCE {
```

| | |
|---|---|
| detectedSatellites-r17 | DetailedReportedSatellites-r17, |
| usedSatellites-r17 | DetailedReportedSatellites-r17, |
| hdopi-r17 | ENUMERATED (f10, f11, f12, f13, f14, f15, f16, |

f17, f18, f19, f20, f21, f22, f23, f24, f25, f26, f27, f28, f29, i3, i4, i5, i6, i8, i10, i15,
i20, gt20},

| | |
|---|---|
| pdopi-r17 | ENUMERATED (f10, f11, f12, f13, f14, f15, f16, |

f17, f18, f19, f20, f21, f22, f23, f24, f25, f26, f27, f28, f29, i3, i4, i5, i6, i8, i10, i15,
i20, gt20} OPTIONAL,

| | |
|---|---|
| fixq-r17 | INTEGER (0..8), |

```
  }
  DetailedReportedSatellites-r17 ::= SEQUENCE (SIZE(1..16)) OF
DetailedReportedSatellitesForOneGNSS-r17
  DetailedReportedSatellitesForOneGNSS-r17 ::= SEQUENCE {
```

| | |
|---|---|
| gnss-ID-r17 | GNSS-ID, |
| nrofSatellites-r17 | INTEGER (0..64), |
| gnssSignalIDs-r17 | GNSS-SignalIDs, |
| cNo-r17 | INTEGER (0..63), |
| mpathDet-r17 | ENUMERATED {notMeasured (0), low (1), medium |

```
(2), high (3), ...},
    ...
  }
  -- ASN1STOP
```

GNSS-LocationInformation field descriptions
nrofDetectedSatellites

This field specifies number of detected GNSS satellites by the target

device
nrofUsedSatellites

This field specifies number of used GNSS satellites for the location

estimate provided by the target device
hdopi

This field specifies the horizontal dilution of precision for the

location estimate, where

| | |
|---|---|
| - | f10, f11, ..., f29 corresponds to 1.0, 1.1, ..., 2.9 |
| - | i3, i4, i5, i6, i8, i10, i15, i20 corresponds to 3, 4, 5, 6, 8, 10, |

15, 20

| | |
|---|---|
| - | gt20 corresponds to greater than 20 |

pdopi

This field specifies the 3D position dilution of precision, with same

encoding as hdopi
fixq

| This field specifies the positioning fix quality indicator, where | |
|---|---|
| - | 0 = Invalid, no position available. |
| - | 1 = Autonomous GPS fix, no correction data used. |
| - | 2 = DGPS fix, using a local DGPS base station or correction |

service such as WAAS or EGNOS.

| | |
|---|---|
| - | 3 = PPS fix |
| - | 4 = RTK fix |
| - | 5 = RTK Float |
| - | 6 = Estimated fix (dead reckoning). |
| - | 7 = Manual input mode. |
| - | 8 = Simulation mode. |

detectedSatellites

This field specifies details about of detected GNSS satellites by the

target device
usedSatellites

This field specifies details about of used GNSS satellites by the

target device
gnssSignalIDs

This field specifies the GNSS signal types used by the target device

to determine the location estimate. This is represented by a bit string in
GNSS-SignalIDs, with a one-value at the bit position means that the
particular GNSS signal type was used; a zero-value means not used.
cNo

This field provides an estimate of the carrier-to-noise ratio of the

received signal from the strongest satellite. The target device sets this
field to the value of the satellite C/N₀, as referenced to the antenna
connector, in units of 1 dB-Hz, in the range from 0 to 63 dB-Hz.

Scale factor 1 dB-Hz.

mpathDet

This field contains the multipath indicator value, defined in the table

Value of mpathDet to Multipath Indication relation described for the IE
GNSS-MeasurementList

### Local Environment GNSS Positioning Metrics

### Assistance Data Representation

Indications are described in the context of LPP, but may be generalized to other means to transfer local environment GNSS positioning metrics.

The local environment GNSS positioning metrics may be represented in a few different ways, including:
a geographical reference:
   a logical region such as a cell, beam, tracking area, area where a reference signal is dominating other reference signals;
   a physical region such as a location, a set of locations, a line segment, a polygon;
local environment GNSS positioning metrics:
   number of detected satellites and the number of satellites used for positioning;
   satellite quality information in terms of signal to noise ratio of carrier to noise ratio
   These values for the set of all satellite signal measurements is to be reduced to a value representing them. The representative value may be, for example:
      the average value for the set of satellite signal measurements used for estimating the position;
      the strongest value over the set of satellite signal measurements; and/or
      the Nth strongest value of the set of satellite signal measurements;
The geometry of the set of satellites used for positioning, for example in terms of geometric dilution of precision (GDOP) or Horizontal Dilution of Precision (HDOP);
The positioning engine position estimate classification, such as standalone (no assistance data used), differential GPS assistance data used, GNSS RTK float solution (number of signal wavelengths to the satellites represented by a non-integer), GNSS RTK fix solution (number of signal wavelengths to the satellites represented by a integer), estimated fix such as using an IMU. The representation may be based on the categories defined in NMEA GGA sentences for position estimate information.
   0=Invalid, no position available;
   1=Autonomous GPS fix, no correction data used;
   2=DGPS fix, using a local DGPS base station or correction service such as WAAS or EGNOS;
   3=PPS fix;
   4=RTK fix;
   5=RTK Float;
   6=Estimated fix (dead reckoning);
   7=Manual input mode;
   8=Simulation mode.

### LPP Encoding of the Assistance Data

### Steps 520, 630, 704, 802, 1002, 1450:

### GNSS-CommonAssistData

The IE GNSS-CommonAssistData may be used by the location server to provide assistance data which may be used for any GNSS:

```
  -- ASN1START
  GNSS-CommonAssistData ::= SEQUENCE {
```

| | |
|---|---|
| gnss-ReferenceTime | GNSS-ReferenceTime |

OPTIONAL, -- Need ON

| | |
|---|---|
| gnss-ReferenceLocation | GNSS-ReferenceLocation |

OPTIONAL, -- Need ON

| | |
|---|---|
| gnss-IonosphericModel | GNSS-IonosphericModel |

OPTIONAL, -- Need ON

| | |
|---|---|
| gnss-EarthOrientationParameters | GNSS-EarthOrientationParameters |

```
OPTIONAL, -- Need ON
    ...,
    [[
      gnss-RTK-ReferenceStationInfo-r15
```

GNSS-RTK-ReferenceStationInfo-r15

OPTIONAL, -- Need ON
gnss-RTK-CommonObservationInfo-r15

GNSS-RTK-CommonObservationInfo-r15

OPTIONAL, -- Cond RTK
gnss-RTK-AuxiliaryStationData-r15

GNSS-RTK-AuxiliaryStationData-r15

```
OPTIONAL -- Need ON
    ]],
    [[
      gnss-SSR-CorrectionPoints-r16
```

GNSS-SSR-CorrectionPoints-r16

```
OPTIONAL -- Need ON
    ]]
  }
  -- ASN1STOP
```

| Conditional | |
|---|---|
| presence | Explanation |
| RTK | The field is present if the IE GNSS-RTK- |
| | Observations is included in IE |
| | GNSS-GenericAssistData; otherwise it is not present. |

### GNSS-ReferenceLocation

The IE GNSS-ReferenceLocation may be used by the location server to provide the target WD 22 with a-priori knowledge of its location in order to improve GNSS receiver performance. The IE GNSS-ReferenceLocation is provided in the WGS-84 reference system:

```
    -- ASN1START
    GNSS-ReferenceLocation ::= SEQUENCE {
        threeDlocation
  EllipsoidPointWithAltitudeAndUncertaintyEllipsoid,
        ...,
        [[
```

| | | |
|---|---|---|
| gnss-metrics-r17 | GNSS-Metrics-r17 | OPTIONAL, |

```
        ]]
    }
    GNSS-Metrics-r17 ::= SEQUENCE
```

| | | |
|---|---|---|
| nrofDetectedSatellites-r17 | INTEGER (0..128) | OPTIONAL, |
| nrofUsedSatellites-r17 | INTEGER (0..64) | OPTIONAL, |

| | |
|---|---|
| hdopi-r17 | ENUMERATED (f10, f11, f12, f13, f14, f15, f16, |

f17, f18, f19, f20, f21, f22, f23, f24, f25, f26, f27, f28, f29, i3, i4, i5, i6, i8, i10, i15,
i20, gt20},

| | |
|---|---|
| pdopi-r17 | ENUMERATED (f10, f11, f12, f13, f14, f15, f16, |

f17, f18, f19, f20, f21, f22, f23, f24, f25, f26, f27, f28, f29, i3, i4, i5, i6, i8, i10, i15,
i20, gt20}
OPTIONAL,

| | | |
|---|---|---|
| fixqs-r17 | BIT STRING (SIZE(9)) | OPTIONAL, |

```
    }
    -- ASN1STOP
```

GNSS-ReferenceLocation field descriptions
nrofDetectedSatellites

This field specifies average number of detected GNSS satellites

at the reference location
nrofUsedSatellites

This field specifies average number of used GNSS satellites at the

reference location
hdopi

This field specifies the horizontal dilution of precision at the

reference location, where

| | |
|---|---|
| - | f10, f11, ..., f29 corresponds to 1.0, 1.1, ..., 2.9 |
| - | i3, i4, i5, i6, i8, i10, i15, i20 corresponds to 3, 4, 5, 6, 8, 10, 15, 20 |

gt20 corresponds to greater than 20

pdopi

This field specifies the 3D position dilution of precision, with same

encoding as hdopi
fixqs

This field specifies the reported positioning fix quality indicators

at the reference location, where

| | |
|---|---|
| - | Bit 1 = Invalid, no position available. |
| - | Bit 2 = Autonomous GPS fix, no correction data used. |
| - | Bit 3 = DGPS fix, using a local DGPS base station or correction |

service such as WAAS or EGNOS.

| | |
|---|---|
| - | Bit 4 = PPS fix |
| - | Bit 5 = RTK fix |
| - | Bit 6 = RTK Float |
| - | Bit 7 = Estimated fix (dead reckoning). |
| - | Bit 8 = Manual input mode. |
| - | Bit 9 = Simulation mode. |

### Unicast

The signaling described herein may apply to LPP or other client server protocols. The LPP transactions may be the same independent of whether control plane signaling or user plane signaling via secure user plane (SUPL) is used.

From the perspective of the WD, FIG. 10 illustrates steps performed in some embodiments.

### Broadcast

In addition, the local environment GNSS positioning metrics may also be broadcasted.

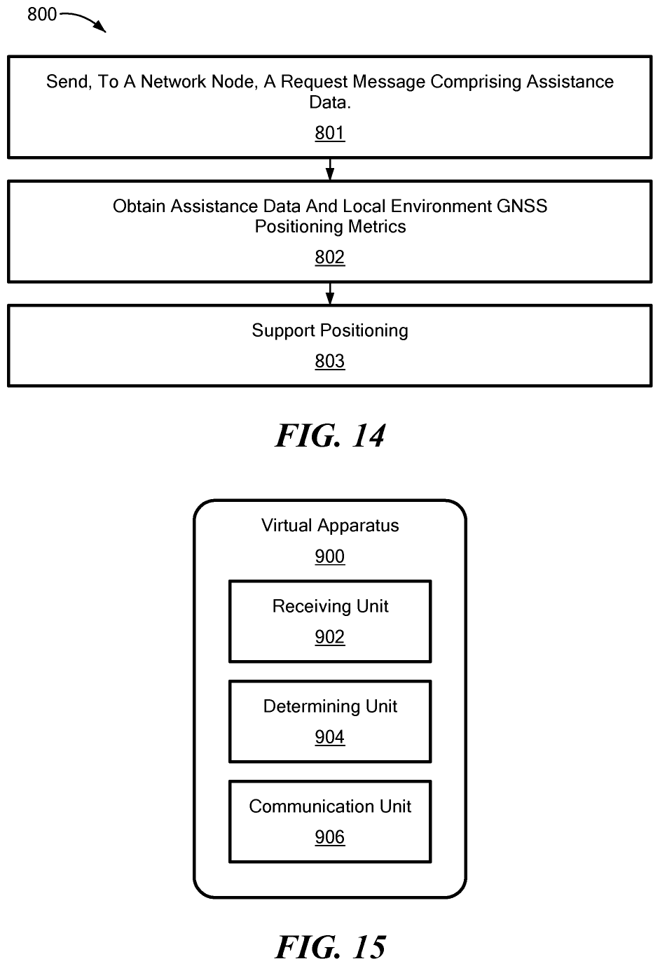

FIG. 14 is a flowchart of an example process in a WD 22 for obtaining regional GNSS position assistance data. The process includes sending (Step 801) to a network node, a request message comprising assistance data. The process also includes obtaining (Step 802) assistance data and local environment GNSS positioning metrics. The process also includes supporting (Step 803) positioning.

FIG. 15 is a block diagram of a virtual apparatus such as a virtual WD 22 constructed according to principles disclosed herein. The virtual apparatus 900, including the receiving unit 902, determining unit 904 and the communication unit 906 may be implemented by the WD 22 (or some other device) via the processing circuitry 50 and the radio interface 46 that may include a virtual machine layer and a virtualization layer that allows processing circuitry to be virtually partitioned and shared in order to create one or more virtual WDs that may execute one or more applications within each virtual WD.

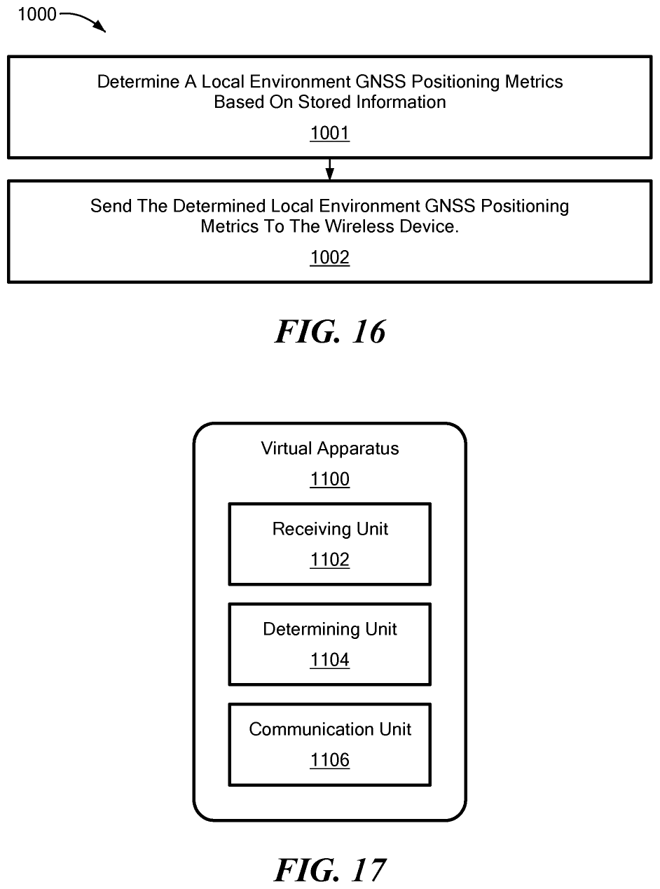

FIG. 16 is flowchart of an example process in a network node 16 for determining regional GNSS position assistance data. One or more blocks described herein may be performed by one or more elements of network node 16 such as by one or more of processing circuitry 36 (including the regional metrics unit 24), processor 38, and/or radio interface 30. The process includes determining (Step 1001) a local environment GNSS positioning metrics based on stored information. The process also includes sending (Step 1002) the determined local environment GNSS positioning metrics to the wireless WD 22.

FIG. 17 is a block diagram of a virtual apparatus such as a network node 16 constructed according to principles herein. The virtual apparatus 1100, including the receiving unit 1102, determining unit 1104 and the communication unit 1106 may be implemented by the network node 16 via the processing circuitry 36 and the radio interface 30 that may include a virtual machine layer and a virtualization layer that allows processing circuitry to be virtually partitioned and shared in order to create one or more virtual network nodes that may execute one or more applications within each virtual network node.

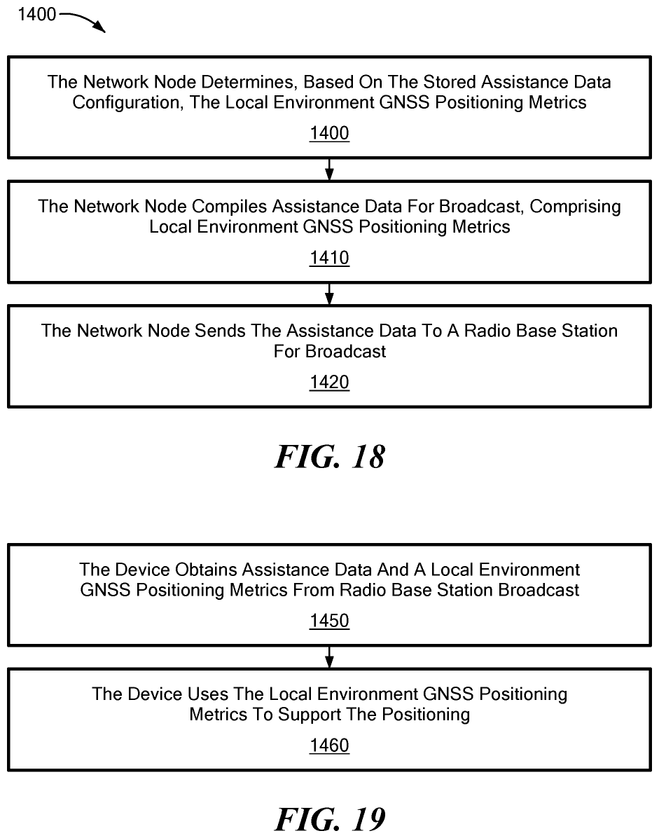

FIG. 18 is shows a flowchart in an example process in a network node. FIG. 19 is an example process in a wireless device 22. One or more blocks described herein may be performed by one or more elements of wireless device 22 such as by one or more of processing circuitry 50 (including the local metrics unit 26), processor 52, and/or radio interface 46. In step 1400, the network node determines, based on stored assistance data configuration, local environment GNSS positioning metrics. In step 1410, the location server compiles assistance data for broadcast that includes the local environment GNSS positioning metrics. In step 1420, the network node provides to the network node 16, assistance data together with a local environment GNSS positioning metrics.

From the WD 22 perspective, in step 1450, the WD 22 obtains assistance data and local environment GNSS positioning metrics from network node 16 broadcast. In step 1460, the WD 22 uses the local environment GNSS positioning metrics to assess positioning performance.

Some embodiments include reporting of local environment GNSS positioning metrics to establish performance understanding in a network node such as a location server. Based on stored GNSS positioning metrics, the network node may prepare regional GNSS positioning metrics to warn a WD about expected regional performance.

Some examples may include one or more of the following:

Example A1. A network node configured to communicate with a wireless device (WD), the network node configured to, and/or comprising a radio interface and/or comprising processing circuitry configured to:
determine regional local environment global navigation satellite system, GNSS, positioning metrics;
determine positioning assistance data based at least in part on the positioning metrics; and
transmit the positioning metrics and positioning assistance data to the WD.

Example A2. The network node of Example A1, wherein the network node, radio interface and/or processing circuitry are further configured to pre-determine whether the WD is capable of supporting regional local environment GNSS positioning metrics.

Example A3. The network node of any of Examples A1 and A2, wherein the positioning metrics are determined based at least in part on stored assistance data.

Example A4. The network node of any of Examples A1-A3, wherein the positioning metrics are based at least in part on at least one of a geographical reference, satellite signal measurements and satellite positions.

Example B1. A method implemented in a network node that is configured to communicate with a wireless device, the method comprising:
determining regional local environment global navigation satellite system, GNSS, positioning metrics;
determining positioning assistance data based at least in part on the positioning metrics; and
transmitting the positioning metrics and positioning assistance data to the WD.

Example B2. The method of Example B1, further comprising pre-determining whether the WD is capable of supporting regional local environment GNSS positioning metrics.

Example B3. The method of any of Examples B1 and B2, wherein the positioning metrics are determined based at least in part on stored assistance data.

Example B4. The method of any of Examples B1-B3, wherein the positioning metrics are based at least in part on at least one of a geographical reference, satellite signal measurements and satellite positions.

Example C1. A wireless device (WD) configured to communicate with a network node, the WD configured to, and/or comprising a radio interface and/or processing circuitry configured to:
receive from the network node a request for local environment global navigation satellite system, GNSS, positioning metrics and positioning information;
determine the requested local environment GNSS positioning metrics and positioning information; and
transmit the determined local environment GNSS positioning metrics and positioning information to the network node.

Example C2. The WD of Example C1, wherein the WD, radio interface and/or processing circuitry are further configured to receive regional local environment GNSS positioning metrics from the network node and determine the positioning information based at least in part on the regional local environment GNSS positioning metrics.

Example C3. The WD of any of Examples C1 and C2, wherein the local environment GNSS positioning metrics are based at least in part on at least one of satellite signal measurements, satellite positions and differential positioning assistance information.

Example C4. The WD of any of Examples C1-C3, wherein the WD, radio interface and/or processing circuitry are further configured to transmit to the network node a capability to use regional local environment GNSS positioning metrics.

Example D1. A method implemented in a wireless device (WD) that is configured to communicate with a network node, the method comprising: receiving from the network node a request for local environment global navigation satellite system, GNSS, positioning metrics and positioning information; determining the requested local environment GNSS positioning metrics and positioning information; and transmitting the determined local environment GNSS positioning metrics and positioning information to the network node.

Example D2. The method of Example D1, further comprising receiving regional local environment GNSS positioning metrics from the network node and determine the positioning information based at least in part on the regional local environment GNSS positioning metrics.

Example D3. The method of any of Examples D1 and D2, wherein the local environment GNSS positioning metrics are based at least in part on at least one of satellite signal measurements, satellite positions and differential positioning assistance information.

Example D4. The method of any of Examples D1-D3, further comprising transmitting to the network node a capability to use regional local environment GNSS positioning metrics.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| 5GC | 5G Core |
| AMF | Access and Mobility Management Function |
| DL-PRS | Downlink positioning reference signal |
| DOP | Dilution of Precision |
| EPC | Evolved Packet Core |
| E-SMLC | Evolved-Serving Mobile Location Centre |
| GDOP | Geometric Dilution of Precision |
| GNSS | Global Navigation Satellite System |
| HDOP | Horizontal Dilution of Precision |
| LMF | Location Management Function |
| LPP | LTE Positioning Protocol |
| LPPa | LTE Positioning Protocol Annex |
| LTE | Long Term Evolution |
| MDT | Minimization of Drive Test |
| MME | Mobility Management Entity |
| MSM | Multiple Signal Message |
| NR | New Radio |
| RRC | Radio Resource Control |
| RTK | Real Time Kinematic |
| SET | SUPL Enabled Terminal |
| SLP | SUPL Location Platform |
| SUPL | Secure UserPlane Location |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node configured to communicate with a plurality of wireless devices, WDs, the method comprising:
obtaining a capability of the WD to provide GNSS positioning metrics;
requesting the WD to provide GNSS positioning metrics with a location estimate, when a location estimate is available at the WD;
receiving from a plurality of WDs, local GNSS positioning metrics associated to the reported location estimate;
determining local GNSS positioning metrics applicable to the plurality of WDs; and
transmitting a set of local GNSS positioning metrics to be used by at least one WD.

2. The method of claim 1, wherein the local GNSS positioning metrics include, for each of at least one WD, a number of detected satellites and a number of satellites used for positioning.

3. The method of claim 1, wherein the set of local GNSS positioning metrics include satellite signal quality information.

4. The method of claim 3, wherein the satellite signal quality information includes an indication whether a satellite signal is line of sight.

5. The method of claim 1, wherein the set of local GNSS positioning metrics include an average of satellite signal measurements.

6. The method of claim 1, wherein the set of local GNSS positioning metrics include a dilution of precision received from at least one WD of the plurality of WDs.

7. The method of claim 1, wherein the set of local GNSS positioning metrics include a geographical reference, the geographical reference including at least one of a cell, a beam, a tracking area, a location, a line segment and a polygon.

8. The method of claim 1, wherein the set of local GNSS positioning metrics include metrics based at least in part on position estimate classifications, the position estimate classifications including an indication of at least one of differential positioning assistance data, real time kinetic solution information and inertial measurement unit data.

9. The method of claim 1, wherein the local GNSS positioning metrics are filtered based at least in part on a comparison of satellite signal measurements to at least one of a signal quality threshold and a signal power threshold.

10. The method of claim 1, wherein transmitting the set of local GNSS positioning metrics to at least one WD includes one of broadcasting and unicasting the set of local GNSS positioning metrics.

11. The method of claim 1, wherein the network node is a location server.

12. A network node configured to communicate with a plurality of wireless devices, WDs, the network node comprising:
processing circuitry configured to:
obtain a capability of the WD to provide GNSS positioning metrics;
request the WD to provide GNSS positioning metrics with a location estimate, when a location estimate is available at the WD;
a radio interface in communication with the processing circuitry and configured to receive from a plurality of WDs, local GNSS positioning metrics associated to a reported location estimate; and
the processing circuitry being further configured to determine local GNSS positioning metrics applicable to the plurality of WDs; and
the radio interface being further configured to transmit a set of local GNSS positioning metrics to be used by at least one WD.

13. The network node of claim 12, wherein the local GNSS positioning metrics includes, for each of at least one WD, a number of detected satellites and a number of satellites used for positioning.

14.-22. (canceled)

23. A method in a WD configured to communicate with a network node and a plurality of satellites, the method comprising:
transmitting to the network node a capability of the WD for providing GNSS positioning metrics;
receiving a request from the network node to provide GNSS positioning metrics with a location estimate, when a location estimate is available at the WD;
determining local GNSS positioning metrics based at least in part on satellite signal measurements by the WD;
reporting the local GNSS positioning metrics with a location estimate when a location estimate is available at the WD;
receiving GNSS positioning metrics from the network node, the GNSS positioning metrics being based at least in part on local GNSS positioning metrics received from a plurality of WDs; and
determining a position of the WD based at least in part on the local and regional GNSS positioning metrics.

24. The method of claim 23, wherein the local GNSS positioning metrics include, for each of at least one WD, a number of detected satellites and a number of satellites used for positioning.

25. The method of claim 23, wherein the GNSS positioning metrics include satellite signal quality information.

26. The method of claim 25, wherein the satellite signal quality information includes an indication whether a satellite signal is line of sight.

27. The method of claim 23, wherein the GNSS positioning metrics include a dilution of precision from at least one of the plurality of WDs.

28. The method of claim 23, wherein the local GNSS positioning metrics are based at least in part on comparisons of satellite signal measurements to at least one of a signal quality threshold and a signal power threshold.

29. The method of claim 23, wherein the local GNSS positioning metrics include metrics based at least in part on position estimate classifications, the position estimate classifications including an indication of at least one of differential positioning assistance data, real time kinetic solution information and inertial measurement unit data.

30. A wireless device configured to communicate with a network node and a plurality of satellites, the WD comprising:
a radio interface configured to:
transmit to the network node a capability of the WD for providing GNSS positioning metrics; and
receive a request from the network node to provide GNSS positioning metrics with a location estimate, when a location estimate is available at the WD; and
processing circuitry in communication with the radio interface and configured to determine local GNSS positioning metrics based at least in part on satellite signal measurements by the WD;
the radio interface being further configured to:
report the local GNSS positioning metrics with a location estimate when a location estimate is available at the WD; and
receive GNSS positioning metrics from the network node, the GNSS positioning metrics being based at least in part on local GNSS positioning metrics received from a plurality of WDs; and
the processing circuitry being further configured to determine a position of the WD based at least in part on the local and regional GNSS positioning metrics.

31. The WD of claim 30, wherein the local GNSS positioning metrics include, for each of at least one WD, a number of detected satellites and a number of satellites used for positioning.

32.-36. (canceled)
